(19) United States
(12) Patent Application Publication
(10) Pub. No.: US 2018/0346819 A1
(43) Pub. Date: Dec. 6, 2018

(54) METHOD AND APPARATUS FOR EXTRACTING BITUMEN FROM OIL-WETTED TAR SANDS AND CONVERTING IT TO USEFUL PETROLEUM PRODUCTS

(71) Applicant: VivaRRT, LLC, Irvine, CA (US)

(72) Inventors: Matt Nicosia, Bluffdale, UT (US); Ronald Patrick Garrett, Irvine, CA (US); Keith Allen Chapman, Oak Grove, MO (US)

(21) Appl. No.: 15/831,355

(22) Filed: Dec. 4, 2017

Related U.S. Application Data
(60) Provisional application No. 62/429,775, filed on Dec. 3, 2016.

(51) Int. Cl. C10G 1/04; C10G 1/00; B09C 1/06; B04B 3/04

(52) U.S. Cl. CPC C10G 1/045; C10G 1/002; G05B 19/056; B09C 1/065; B04B 3/04; C10G 1/047

(57) ABSTRACT

A method and apparatus for extracting bitumen and other hydrocarbons from oil-wetted tar sands and converting it to useful petroleum products, the method comprising first mixing the tar sands material with a condensate consisting oil material and agitating the resulting slurry. After agitating the slurry it is passed through a dual-phase centrifuge and the bitumen and heavy end hydrocarbons are removed, while the light end hydrocarbons remain in the centrifuge cake. The centrifuge cake is heated as it passes through an indirect fired rotary thermal desorber and the hydrocarbon material evaporates are cooled in a quench tank to be collected in the quench supply and recovery tank. The process can also be applied to materials which have become contaminated by hydrocarbons, to extract and remove the hydrocarbons. Another embodiment of the process involves using the indirect fired rotary thermal desorber to treat either tar sands material or a centrifuge cake and quenching the hydrocarbon material evaporates within the quench tank to be collected in the quench supply and recovery tank.

### CROSS-REFERENCE TO RELATED APPLICATIONS

Not Applicable.

### STATEMENT REGARDING FEDERALLY SPONSORED RESEARCH OR DEVELOPMENT

Not Applicable.

### BACKGROUND

### 1. The Field of the Present Disclosure

The present invention relates, generally, to processes for extracting bitumen and other hydrocarbons from tar sands and, more specifically, to a method and apparatus for extracting bitumen from oil-wetted tar sands and converting it to useful petroleum products.

### 2. Description of Related Art

Rystad Energy, a Norwegian consulting firm, estimates that the world has about 2,092 billion barrels of recoverable petroleum reserves. Since the beginning of recorded history, some 1,300 billion barrels of oil have been produced world wide. At the current production rate of 30 billion barrels per year, that supply will be exhausted in about 70 years. However, the current production rate is likely to increase dramatically with the number of petroleum-powered vehicles on the road expected to double from 1 billion to 2 billion over the next 30 years. While there is still a lot of oil left in the world to be recovered, according to this estimate, most of it is of unconventional varieties. Rystad estimates that the U.S. has the largest petroleum reserves of any nation on earth. Estimated to be equivalent to about 264 billion barrels of oil, more than half of that amount in the form of kerogen, an “immature oil” found in oil shale deposits. Kerogen, a mixture or organic chemical components that make up a portion of the organic matter in sedimentary rocks such as carbonate or marlstone, is insoluble in normal organic solvents because of the high molecular weight of its component compounds. The soluble portion of organic matter in the rock is known as bitumen. Kerogen is a mixture of organic chemical compounds that make up a portion of the organic matter in sedimentary rocks, such as carbonate or marlstone. Kerogen must undergo a form of upgrading (e.g. retorting) wherein this solid form of elemental hydrocarbon is heated to approximately 370° C. to remove excess nitrogen and complete its conversion to a liquid hydrocarbon. Retorted kerogen from oil shale is suitable for refining into numerous high value products including diesel fuel, jet fuel and gasoline.

About an eighth of total world petroleum reserves is in the form of tar sands. Tar sands (also referred to as oil sands) are a combination of clay, sand, water, and bitumen—a sticky, black and highly-viscous or semi-solid form of petroleum that is also known as asphalt. In some cases, such as many tar sands in Venuzuela, the hydrocarbon constituent in tar sands is extra-heavy crude, rather than bitumen.

While tar sands are found in many places worldwide, the largest deposits in the world are located in Alberta, Canada (176.8 billion barrels), the Orinoco Belt in Venezuela (235 billion barrels), and much of the rest is found in various countries in the Middle East. In the United States, tar sands resources are primarily concentrated, mostly on federal public lands, in Eastern Utah. The in-place tar sands oil resources in Utah deemed recoverable are estimated to contain the equivalent of 12 to 19 billion barrels of oil. All such reserves, as well as others, have a need for improved recovery.

Currently, oil is not produced from tar sands on a significant commercial level in the United States; In fact, only Canada has a large-scale commercial tar sands industry, though a small amount of oil from tar sands is produced commercially in Venezuela. The Canadian tar sands industry in Alberta produces more than one million barrels of synthetic oil per day. Currently, tar sands represent about forty percent of Canada's oil production, and output is expanding rapidly. Approximately twenty percent of U.S. crude oil and products come from Canada, and a substantial portion of this amount comes from tar sands.

The bitumen in tar sands cannot be pumped from the ground in its natural state; Instead tar sand deposits are mined, usually using strip mining or open pit techniques, or the oil is extracted by underground heating with additional upgrading. Although after processing, the oil from tar sands is similar to oil pumped from conventional oil wells, extraction of oil from tar sands is much more complex than conventional oil recovery. Oil sands recovery processes include extraction and separation systems to separate the bitumen from the clay, sand, and water that make up the tar sands. Like kerogen, bitumen also requires additional upgrading before it can be refined. Because it is so viscous (thick), it also requires dilution with lighter hydrocarbons to make it transportable by pipelines.

New methods introduced in the 1990s considerably improved the efficiency of tar sands mining, thus reducing the cost. These systems use large hydraulic and electrically powered shovels to dig up tar sands and load them into enormous trucks that can carry up to 320 tons of tar sands per load.

There are two different types of tar sands: “oil-wetted” tar sands and “water-wetted” tar sands. The Canadian tar sands that have been successfully exploited are water-wetted tar sands. They have water contents typically in the 3-5% range. Oil wetted tar sands have the bitumen trapped within the pore spaces of the host sandstone, adhering directly to the sand grains without the presence of an intervening film of water (known as connate water).

Currently, the Clark process is utilized in Canada to extract the bitumen from water-wetted tar sands. After mining, these tar sands are transported to an extraction plant, where a hot water process separates the bitumen from sand, water, and minerals. The separation takes place in separation cells. Hot water is added to the sand, and the resulting slurry is piped to the extraction plant where it is agitated. The combination of hot water and agitation releases bitumen from the oil sand, and causes tiny air bubbles to attach to the bitumen droplets, that float to the top of the separation vessel, where the bitumen can be skimmed off. Further processing removes residual water and solids. The bitumen is then transported and eventually upgraded into synthetic crude oil. Alberta tar sands contain an average of about ten percent bitumen by weight. About two tons of tar sands are required to produce one barrel of oil from tar sands in Alberta, Canada. Using the Clark process, roughly 75% of the bitumen can be recovered from sand. After oil extraction, the spent sand and other materials are then returned to the mine, which is eventually reclaimed.

Processes other than the Clark process can be used to extract bitumen from water-wetted tar sands which are buried too deep for economical mining operations. This includes using in-situ production methods such as steam injection, solvent injection, and firefloods, in which oxygen is injected and part of the resource burned to provide heat. To date, steam injection is the favored method. Some of these methods require large amounts of both water and energy.

Variants of the Clark process have also been tried in extracting bitumen from oil-wetted tar sands. However, as oil-wetted tar sands lack connate water, these attempts have met with failure or limited success due to the Clark process's reliance on connate water.

To date, oil-wetted tar sands can be processed by treating them with an organic solvent that dissolves the tar, which is then recovered as a straight bitumen product.

However, this solvent process has proved to be commercially unviable for three reasons. The first reason is the high cost of the organic solvents, which are not completely recoverable. The second reason is that the recovered bitumen must be subjected to a cracking process, which adds to processing costs, and results in a reduction of recoverable hydrocarbons. The third reason is that the sands from which the hydrocarbon compounds were extracted become an environmental catastrophe. When the extraction process involves the use of a solvent, and any hydrocarbons from either the extraction solvent or the tar, itself, remain in the final sand product, it is likely to be subject to the provisions of the U.S. Resource Conservation and Recovery Act (RCRA), a federal law promulgated by the U.S. Environmental Protection Agency (EPA), in accordance with a U.S. Congressional mandate, that establishes the framework for the proper management of hazardous and non-hazardous solid waste.

What is needed is a new, solvent-free process for extracting bitumen from oil-wetted tar sands. As in Alberta, huge shovels and trucks will be employed for the actual mining of the tar sands. Ideally, the extraction process will not require inputs of energy from outside sources, will leave the final sand and clay product virtually bitumen free, and will produce hydrocarbon products that can be used, if desired, without additional cracking and refining.

In addition, hydrocarbons can often be spilled onto various materials and it is an expensive process to clean them and remove them from these materials. An improved process that allows complete removal of hydrocarbons from environmental material would also be a valuable addition to the state of the art.

### BRIEF SUMMARY

The present disclosure provides a method and apparatus for extracting bitumen from oil-wetted tar sands and converting it to useful petroleum products. The apparatus is highly portable so that it can be relocated close to tar sand mining operations.

The present disclosure provides a bitumen extraction and processing method that it can be completely self-sustaining. If a waste oil generator is used to generate the electricity required to operate the machinery, all of the energy can be derived from the tar sands themselves.

Although an extraction fluid is required to implement the process, that too can be provided directly from the tar sands. All that is needed to start the described process is short-term generation of electricity to power equipment required to implement the process.

Though this specification is written towards the removal of Bitumen from oil sands material, the process and apparatus described can also be used to extract hydrocarbons from the environment in a wide variety of situations, as will become apparent to those skilled in the art. This includes the removal of hydrocarbons from material which have become contaminated by them, for example. When used to clean up contaminated materials, instead of being done with tar sands, the process is done with the contaminated materials. In addition, Bitumen is only one example of a hydrocarbon which can be removed using this process. Other hydrocarbons can be extracted and either used (when the process is used in mining), or properly disposed of (when the process is used to clean up contaminated materials).

One described apparatus includes a crusher to pulverize the mined tar sand materials or contaminated materials; primary material mix and agitation tank; a variable-speed first conveyor belt to feed pulverized tar sand material into the material mix tank, which also receives extraction fluid in the form of condensate; a secondary material mix and agitation tank, which receives a mixed and agitated mixture of condensate-solvated bitumen, sand and clay from the primary material mix and agitation tank via a first conduit coupled to a first transfer pump; a dual-phase centrifuge that receives the condensate-solvated bitumen, sand and clay via a second conduit coupled to a second transfer pump; a surge tank that receives the heavy ends (carbon chains, each of which has 12 or more carbon atoms) of the condensate and bitumen components from the high-density exit port of the dual-phase centrifuge; and a centrifuge screw that receives centrifuge cake from a low density exit port of the centrifuge. The centrifuge cake includes the sand and clay solids, in combination with about 12 percent liquid content that comprises the light ends (carbon chains, each of which has about 8 to 11 carbon atoms).

The centrifuge screw transports the centrifuge cake to a second variable-speed conveyor belt that delivers the centrifuge cake to a hopper on an air-tight auger that directly feeds the front end of an indirect-fired rotary thermal desorber (RTD) that is sealed against the entry of air. The RTD is equipped with internal flights (much like those in an Archimedes screw) that move the centrifuge cake toward an exit at the opposite end of the RTD as the barrel axially rotates.

It has been shown that all hydrocarbon chains in tar sands will vaporize if a constant temperature of at least 400° C. (about 750° F.) is maintained. Thus, in the described apparatus and process, operators strive to maintain RTD internal temperatures within a range of about 418 to about 427° C. (about 785 to about 800° F.). The light-end hydrocarbon chains in the cake are volatized by the high temperatures within the RTD, pass through a flue at the exit end of the RTD, and are ducted to the top of a vertically oriented quench chamber. The off gases remain in a vapor state as they enter the quench chamber at temperatures within a range of about 316 to about 427° C. (about 600 to about 800° F.)

The off gases entering the quench chamber must be cooled to a temperature lower than about 121° C. (about 250° F.) in order for them to condense to a liquid. The quench chamber is equipped with a number of strategically located spray nozzles which discharge condensate that has been cooled to a temperature lower than about 121° C. (about 250° F.)

In one illustrated embodiment the quench chamber is equipped with three strategically located spray nozzles to discharge condensate. Each spray nozzle is equipped with a valve that can be used to adjust its discharge rate of condensate. As the off gases come in contact with the cool condensate mist, they are also converted to condensate. The bottom of the quench chamber is connected to a quench supply and recovery tank, which is about 30 barrels in one embodiment (a barrel is about a 42-gallon volumetric quantity, with one gallon equaling 3.78541178 liters).

A partial vacuum is applied to the quench tank by a high-capacity exhaust pump that exhausts, first, through a heat exchanger and, secondly, through a vessel containing a carbon filter, thereby applying a partial vacuum to the RTD, itself, and generating an exhaust to the atmosphere that is free of hydrocarbon contaminants.

### BRIEF DESCRIPTION OF THE DRAWINGS

The features and advantages of the disclosure will become apparent from a consideration of the subsequent detailed description presented in connection with the accompanying drawings in which:

FIG. 1 is diagrammatic view of one illustrative apparatus used to extract bitumen from oil-wetted tar sands and convert the extracted bitumen to useful petroleum products.

### DETAILED DESCRIPTION

For the purposes of promoting an understanding of the principles in accordance with the disclosure, reference will now be made to the embodiments illustrated in the drawings and specific language will be used to describe the same. It will nevertheless be understood that no limitation of the scope of the disclosure is thereby intended. Any alterations and further modifications of the inventive features illustrated herein, and any additional applications of the principles of the disclosure as illustrated herein, which would normally occur to one skilled in the relevant art and having possession of this disclosure, are to be considered within the scope of the disclosure claimed. For example, the embodiment described refers to bitumen and oil-wetted tar sands; however, various hydrocarbons can be extracted by using this process from a variety of materials, including materials which have been contaminated by hydrocarbons. In addition, a specific scale of operation is described as the current illustrative embodiment; however, the scale can be increased or decreased by simply adjusting the size of the various parts of the apparatus as will be apparent to one of skill in the art, and no limitation of the scale of operation is intended by this specification. In describing and claiming the present disclosure, the following terminology will be used in accordance with the definitions set out below. As used in this specification and the appended claims, the singular forms “a,” “an,” and “the” include plural referents unless the context clearly dictates otherwise. As used herein, the terms “comprising,” “including,” “having,” “containing,” “characterized by,” and grammatical equivalents thereof are inclusive or open-ended terms that do not exclude additional, unrecited elements or method steps.

A tar sand hydrocarbon extraction and condensate upgrading system, which includes both process and apparatus, has been created that is non-polluting, completely enclosed, and produces at least three useful products. The system conforms to U.S. Environmental Protection Agency (EPA) guidelines as a secondary manufacturing facility. Mined tar sands are processed in such a manner that they are completely recycled. The light ends of the hydrocarbon extraction process (i.e., hydrocarbon chains having from eight to eleven constituent carbon atoms) are removed during the process as a condensate; extracted hydrocarbon streams comprising medium-length carbon chains of from about twelve to eighteen are either burned to provide thermal input for the indirect-fired rotary thermal desorber (RTD) or upgraded to light ends; the heavy carbon chain materials are recirculated through the system to upgrade them to hydrocarbon liquids having short-length chains (light ends) and medium length chains; the hydrocarbon-free solids leaving the RTD can be used as a road building product.

A key feature of the illustrative bitumen extraction and processing method is that it can be completely self sustaining. That is to say, that if a waste oil generator is used to generate the electricity required to operate the machinery, all of the energy can be derived from the tar sands, themselves. Although an extraction fluid is required to implement the process, that too can be provided directly from the tar sands. All that is needed to start the process is short-term generation of electricity to operate the equipment, and a limited amount of condensate to fire the burners of the Rotary Thermal Desorber(RTD) until medium condensates are available to perform that task. The apparatus is highly portable so that it can be relocated close to tar sand mining operations.

Several key elements of the tar sand extraction processes should occur in unison and, because the system is totally enclosed, these key process elements should all start at the same time.

The illustrative method and apparatus for extracting bitumen from oil-wetted tar sands and converting it to useful petroleum products will now be described in detail with reference to the drawing figure.

The apparatus used to implement the process includes a crusher to pulverize the mined tar sand materials, a primary material mix and agitation tank, a variable-speed first conveyor belt to feed pulverized tar sand material into the material mix tank which also receives extraction fluid in the form of condensate, a secondary material mix and agitation tank, which receives a mixed and agitated mixture of condensate-solvated bitumen, sand and clay from the primary material mix and agitation tank via a first conduit coupled to a first transfer pump, a dual-phase centrifuge that receives the condensate-solvated bitumen, sand and clay via a second conduit coupled to a second transfer pump, a surge tank that receives the heavy ends (carbon chains, each of which has 12 or more carbon atoms) of the condensate and bitumen components from the dual-phase centrifuge, a centrifuge screw that receives centrifuge cake, which includes the sand and clay solids in combination with about 12 percent liquid content that comprises the light ends (carbon chains, each of which has about 8 to about 11 carbon atoms) from the dual-phase centrifuge.

The centrifuge screw transports the centrifuge cake to a second variable-speed conveyor belt that delivers the centrifuge cake to a hopper on an airtight auger that directly feeds the front end of the RTD that is sealed against the entry of air. The RTD is equipped with internal flights (much like those in an Archimedes screw) that move the centrifuge cake toward an exit at the opposite end of the RTD as the barrel axially rotates. A flue from the exit end of the RTD is ducted to the top of a vertically-oriented quench chamber, the bottom of which is connected to a quench tank, which has a volume of about 30 barrels in one illustrative embodiment (a barrel is about a 42-gallon volumetric quantity, with one gallon equaling 3.78541178 liters). A partial vacuum is applied to the quench tank by a high-capacity exhaust pump that exhausts, first, through a heat exchanger and, secondly, through a vessel containing a carbon filter, thereby apply a partial vacuum to the RTD, itself, and generating an exhaust to the atmosphere that is free of hydrocarbon contaminants.

One of the distinguishing features of the present disclosure is that extraction fluid for the mechanical separation process is produced on site by means of indirect desorption. The process can be varied, depending on the percentage of bitumen in the available tar sands. If the percentage is high (in excess of roughly about 12 percent by weight), an oil product is produced. If the percentage is lower than about 12 percent by weight, the mixing and agitation steps are suspended, the hydrocarbons are volatized in the RTF and upgrade the condensate through recycling in the quench chamber.

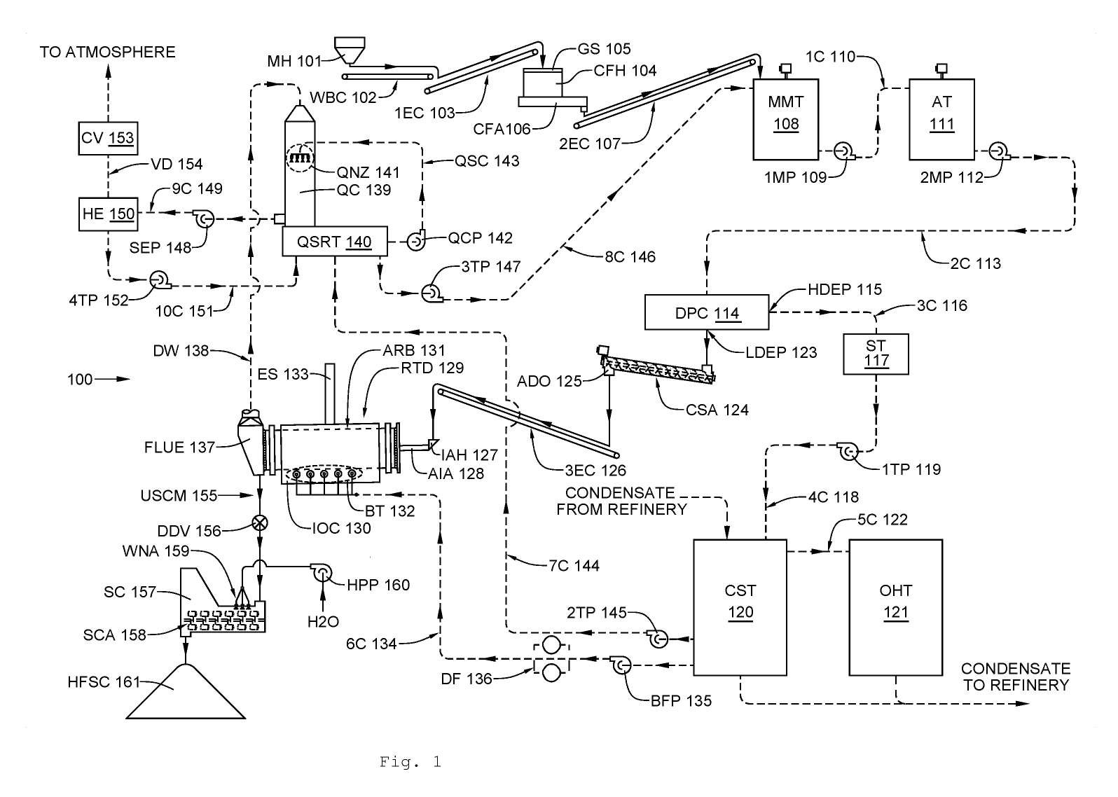

The illustrative process and apparatus for the tar sand hydrocarbon extraction and condensate upgrading system 100 will now be described in detail, with reference to drawing FIG. 1. Each of the underlined headings describes an illustrative step in the process. It will be noted that where the material is described as being moved from one location to another, specific methods used in the illustrative embodiment are described; however, any method of moving the material between the specific operational machinery at the proper rate (where applicable) can be used.

### Pulverization of Mined Tar Sands

Raw mined tar sand material, at first glance, appears to be large clumps of broken up macadam from roads. However, on closer inspection, it will be noted that the material typically contains sand rather than gravel. Nevertheless, the raw tar sand material must be pulverized to that it can be easily processed.

Mined tar sands are initially pulverized with an impact crusher to provide particles that are optimally-sized for further processing. A wheel loader is used to feed raw mined tar sand material to the impact crusher. Crushing is the process of transferring a force amplified by mechanical advantage through a material made of molecules that bond together more strongly, and resist deformation more, than those in the material that is being crushed. The impact crusher holds material between two parallel solid surfaces, and apply sufficient force to bring the surfaces together to generate enough energy within the material being crushed so that its molecules separate from (fracturing), or change alignment in relation to (deformation), each other. The impact crusher can be adjusted to create material sizes from a quarter inch minus to three quarter inch minus. Under most condition, optimum particle size is deemed to be one-quarter inch minus. Small particle size is particularly important at startup, when the RTD is being fed directly by the loader until sufficient condensate is available for the material mix tank and dual-phase centrifuge. While an impact crusher is described in this embodiment of the invention, any method of pulverizing tar sands material into sufficiently small pieces will work for the process.

Once the materials have been run through the crusher they are again scooped up by a wheel loader and fed into a mini hopper (MH) 101 that deposits them onto a short weigh belt conveyor (WBC) 102, having a variable-speed drive, that is set to dump between about 17 and about 24 tons of the pulverized material per hour onto a first elevated conveyor (1EC) 103. A weigh belt conveyor is generally a slow speed conveyor installed with either a single-idler or dual-idler belt weigher.

Weigh belt conveyors provide continuous weighing with high accuracy. The first elevated conveyor transports the material to a clay feeder. The clay feeder consists of a four auger feed system (CFA) 106, powered by a variable-speed electric motor, that sits in a trough covered by a three yard hopper (CFH) 104 with a grizzly screen (GS) 105. The materials are fed onto the grizzly screen 105 by the first elevated belt conveyor 103. The grizzly screen 105 preferably has one inch rectangular openings. As the material is dumped, any particles that do not fit through the openings fall off the screen. Discarded particles can be rerun through the crusher. Any particles that are approximately one inch minus size (under an inch in diameter) fall through the hopper into the feed trough. Clay is a significant component of the tar sands material matrix, so it is important that clay-compatible processing and loading equipment be used.

The feed rate of material delivered to the front end of the process is important because optimum flow of material through all the down stream equipment, in volume per unit of time, must be precisely maintained. Tar sand material from the clay feeder is transported by a second variable-speed elevated feed conveyor (2EC) 107 to a material mix tank (MMT) 108 where it is mixed with hot condensate.

The entire belt conveying system is covered to protect it and the tar sands material from the weather. Preferably, the entire system is enclosed in a building to protect it from the weather.

### Material Mix Tank

The material mix tank (MMT) 108 is employed in the first step in a mechanical separation process. It is, preferably, a cylindrical 35-barrel tank located on the back end of a liquid extraction trailer on which is also mounted the agitation tank (AT) 111 and the dual-phase centrifuge (DPC) 114, in that order. The material mix tank 108 is equipped with an agitation system that utilizes a high-shear-force agitator to mix the materials fed into the tank. The tank has pipe outlets and inlets that can accommodate several different material transfer configurations. Near the top of the material mix tank 108 is a 2-inch pipe fitting, to which is directed hot condensate from the quench supply and recovery tank (QSRT) 140 via an eighth conduit (8C) 146 and a third transfer pump (3TP) 147.

Within the material mix tank (MMT) 108 the hot condensate mixes with the pulverized tar sand material from the clay feeder. The hot condensate functions as an extraction fluid that solvates the alphaltic material, known as bitumen, in the pulverized tar sands material. Although the condensate can be created by feeding pulverized tar sand material directly to the indirect-fired rotary thermal desorber (RTD) 129, the process can be simplified and sped up by initially using condensate acquired from a refinery.

In order to meet the optimum feed for a dual-phase centrifuge positioned downstream in the process, an about 70/30 liquid-to-solid ratio is desired. In order to meet this requirement, in one illustrative embodiment the hot condensate is fed into the material mix tank at a feed rate of about 133 gallons per minute, while the processed tar sand material is fed into the mix tank at a feed rate of about 35 gallons per minute. Though the two product streams enter the tank separately, they are quickly mixed together via the agitator system. At a temperature of about 65° C. (about 140° F.), the asphaltic material, known as bitumen, liquefies and solvates, thereby detaching itself from the sand and clay particle matrix, which enables the slurry of sand, clay, bitumen, and condensate to be pumped.

### Agitation Tank

The agitation tank (AT) 111 is typically the next component in line after the material mix tank 108. The agitation tank 111 is, preferably, also a cylindrical about 35-barrel tank. The slurry of sand, clay, bitumen, and condensate is pumped from the material mix tank into the agitation tank by the first mud pump (1MP) 109 through the first conduit (1C) 110. A mud pump is preferred to move high specific gravity materials. If the liquid materials being transferred need to be cut to a lower viscosity in the agitation tank, additives may be introduced.

The agitation tank 111, though not a necessity, improves the flow rate of tar sand materials through the system. Like the material mix tank 108, the agitation tank 111 is equipped with a high shear force agitation system.

The agitation system continues to mix the slurry that was transferred from the material mix tank.

### Dual-Phase Centrifuge

The slurry of sand, clay, bitumen, and condensate is pumped from the agitation tank (AT) 111 into a dual-phase centrifuge (DPC) 114 having a stainless steel, horizontally-oriented solid bowl via a second conduit (2C) 113 coupled to a second mud pump (2MP) 112. The centrifuge releases condensate solvated bitumen as a liquid stream and produces centrifuge cake composed of sand and clay particles that are wetted with light ends from the tar sands.

Though the centrifuge can vary in size from installation to installation, it always performs the same function. For one particular installation being used to test the process, the centrifuge bowl has a diameter of about 14 inches (about 35.56 cm) and a length of about 56 inches (about 1.4224 m). An auger within the bowl spins at a maximum about 4000 RPM creating a maximum g-force of about 3100 g. The centrifuge is powered by a geared-drive, totally-enclosed fan-cooled (TEFC), variable-frequency, 29.6 kw (40 HP), 230/460Vac, 1800-rpm, back-drivable electric motor. Back-drive-ability is particularly important when moving high-mass loads, so that the motor can coast as the heavy load comes to a rest. Easy back-drive-ability can prevent the load from causing damage to the motor's gear drive. The hydraulic capacity of the centrifuge is about 662.5 liters (175 gallons) per minute.

The centrifuge 114, by subjecting materials present in the mix, which have different specific gravities, to ultra-high g-forces, separates the liquid from the solids. At this stage of the process, about all bitumen should have been released from the tar sands and it will be present in the liquid stream, the components of which have a higher specific gravities than the solid components. However, the solids stream from the centrifuge will not be completely dry: it is wetted with light end hydrocarbon chains having specific gravities comparable to those of the solid particles. The objective is to volatilize these light ends in the RTD 129, and convert them to condensate in the quench chamber (QC) 139.

The liquids from the centrifuge 114 flow from the high-density exit port (HDEP) 115 into a surge tank (ST) 117 via a third conduit (3C) 116, and are subsequently transferred by a first transfer pump (1TP) 119 from the surge tank 117 through a fourth conduit (4C) 118 to a condensate storage tank (CST) 120. Overflow of condensate from the condensate storage tank 120 transfers to an overflow holding tank (OHT) 121 through a fifth conduit (5C) 122. Condensate from either CST 120 or OHT 121 can be pumped into a tanker truck and delivered to a refinery for further processing or, if it has been upgraded, sold for use as diesel fuel.

The centrifuge cake, on the other hand, exits the low-density exit port 123 of centrifuge 114 and is received by a centrifuge screw auger (CSA) 124. The centrifuge cake, includes the sand and clay solids, in combination with about 12 percent liquid content that comprises the light ends (carbon chains, each of which has about 8 to about 11 carbon atoms). The centrifuge screw 124 transports the centrifuge cake to a third variable-speed elevated conveyor belt (3EC) 126 that delivers the centrifuge cake to an infeed auger hopper (IAH) 127 on an air-tight feed auger (AIA) 128 that directly feeds the front end of an indirect-fired rotary thermal desorber (RTD) 129 that is sealed against the entry of air.

It is important to understand that the illustrative system is preferably continuous and not a batch system. All pumps transferring the liquids are preferably set to accurate gallons per minute in order to keep the process running smoothly and uninterrupted. With the exception of the transfer of centrifuge cake to the RTD 129, the illustrative system is completely enclosed.

### Indirect-Fired Rotary Thermal Desorber

An Indirect-Fired Thermal Desorber (RTD) 129 is employed to volatize hydrocarbon compounds within the pulverized tar sands material. Because volatization must occur in an oxygen-free environment to prevent the volatized compounds from combusting, an indirect-fired desorber is employed. The RTD 129 is, essentially, an axially rotatable barrel (ARB) (RK) 131 that is housed within an externally-insulated oven chamber (IOC) 130. The external insulation limits heat loss and renders the process more efficient. A burner train (BT) 132 within the oven chamber heats the exterior of the barrel 131 as it slowly rotates. The barrel 131 is equipped with flights (not shown) that are much like those of an Archimedes screw. The solid tar sands material is introduced at one end of the RTD 129, and the flights transport the pulverized tar sands material through the barrel 131 as it rotates, providing ample opportunity for all hydrocarbon compounds within the tar sands material to volatize before reaching the opposite end of the barrel 131.

When the RTD 129 is fully operational, tar sands can be fed into the rotatable barrel 131 at a rate of about up to 20 tons per hour. The hydrocarbon chains in tar sands vary in length. The carbon chains range from C10 to C35 and, in some circumstances, can even be higher. Each carbon chain number has a unique boiling point. When the boiling point is reached for a particular carbon number, the hydrocarbon chains of that number vaporize to an off gas.

It has been shown that all hydrocarbon chains in tar sands will vaporize if a constant temperature of at least about 400° C. (about 750° F.) is maintained. Thus, equipment operators generally strive to maintain internal temperatures in the barrel 131 within a range of about 418 to about 427° C. (about 785 to about 800° F.). In the event that the barrel 131 begins to overheat, there is a stack (S) 133 on the insulated oven chamber 130 that allows excess heat to be released to the atmosphere. The final products of the RTD 129 include two separate streams.

The first product is an off gas stream that exits through the top of flue (FLUE) 137, travels through ductwork (DW) 138, enters a quench chamber (QC) 139, and is quenched by spraying it with condensate stored in the quench supply and recovery tank (QSRT) 140 that is pumped to multiple and strategically-placed quench spray nozzles (QNZ) 141 by quench circulation pump (QCP) 142 through a quench supply conduit (QSC) 143 to transform it to petroleum condensate that adds to the supply of condensate in QSRT 140.

Condensate from the quench supply and recovery tank (QSRT) 140 is pumped through an eight conduit (8C) 146 to the material mix tank (MMT) 108 by a third transfer pump (3TP) 147, where it serves as an extraction fluid to solvate the bitumen in the tar sands material. Condensate delivered to the MMT 108 from the quench supply and recovery tank (QSRT) 140 can be replenished by having a second transfer pump (2TP) 145 transfer condensate stored in the condensate storage tank (CST) 120 to the QSRT 140 through a seventh conduit (7C) 144. It should be understood that the condensate in the QSRT 140 will generally have a higher API number than condensate stored in the CST 120 because it is being continually pumped to the quench nozzles (QNZ) 141, where it comes into contact with hot off gases being pulled from the RTD 129. This repeated contact with hot off gases implements a cracking process within the quench chamber (QC) 139, which gradually shortens the average chain length of hydrocarbon molecules within the condensate in the QSRT 140.

The second product is a hydrocarbon-free stream of solid particles 161 that can be used in the road building industry. More details will be subsequently provided about conditioning of the stream of solid particles 161 in the description of the soil conditioner.

A system exhaust pump (SEP) 148, or exhaust fan, applies a partial vacuum to the flue (FLUE) 137 at the rear, or exit, of the RTD 129. The exhaust fan sucks out off gasses that are generated and delivers them via the ductwork (DW) 138 to the quench chamber (QC) 139, where they are converted to a condensate. The gasses can vary in temperature by the time they reach the quench chamber, but generally are within a range of about 345 to about 400° C. (about 350 to about 750° F.). In order to cool the incoming off-gases, previously-recovered condensate from the quench supply and recovery tank 140 is sprayed into the quench chamber 139 by the quench spray nozzles (QNZ) 141 in order to cool the incoming off-gases to below 121 EC (250 EF) degrees, hence creating condensate, or oil that adds to the supply of condensate in the quench supply and recovery tank 140.

### Detailed Description of the Indirect-Fired Rotary Thermal Desorber Unit

The indirect-fired rotary thermal desorber (RTD) 129, which includes the airtight infeed auger (AIA) 128, the rotatable barrel (RB) 131, the insulated oven chamber (IOC) 130, the burner train (BT) 132, the exhaust stack (ES) 133, the high-capacity exhaust fan or exhaust pump (SEP) 148, and the double dump valve (DDV) 156 air lock at the exit, will now be disclosed in illustrative detail.

### 1. RTD Auger Feed System

During startup, pulverized, but otherwise unprocessed, tar sand material is loaded directly onto the third elevated belt conveyor (3EC) 126. The pulverized tar sand material drops from the 3EC 126 into an infeed auger hopper (IAH) 127 that feeds an air-tight infeed auger (AIA) 128. After sufficient condensate has been produced, cake wetted with light ends from the dual-phase centrifuge (DPC) 114 is dumped onto the third elevated belt conveyor that feeds the infeed auger hopper 127. Available feed hoppers vary in the amount of material they can hold, but a three cubic yard capacity is common. The in-feed auger hopper 127 is welded onto the casing that contains the air-tight infeed auger (AFA) 128. Infeed augers range in size from ten inches to eighteen inches. An electrical motor, equipped with variable speed control, powers the air-tight infeed auger 128. The infeed auger 128 must be kept full at all times so that oxygen cannot enter the axially rotatable barrel (ARB) 131 and initiate a violent explosion.

### 2. RTD Oven

Tar sands fed into the air-tight infeed auger128 enters the axially rotatatable barrel (ARB) 131 that is surrounded by an insulated oven chamber (IOC) 130. The oven is equipped with a burner train (BT) 132, which includes multiple burner head attachments, to each of which a fuel-fed burner is attached. The burners heat the barrel 131 as it rotates. The insulated oven chamber 130 also has an exhaust stack (ES) 133, through which burner exhaust gases are expelled. The exhaust stack 133 has a controllable exit aperture, which can be enlarged to cool the oven if temperatures within the insulated oven chamber 130 exceed desired maximum temperature settings. Exhaust stack piping within the oven chamber 130 can be directed to other components in the thermal process to add heating value. Piping redirections are typically made only after a week of continuous operation of the oven.

### 3. Rotating Barrel

The axially rotatatable barrel (ARB) 131 within the insulated oven chamber 130 is constructed from a high nickel-chromium alloy that can tolerate temperatures approaching 1093 EC (2,000 EF) without damage. The barrel 131 rotates between about 0.5 and about 3 revolutions per minute depending upon the desired retention time of the material passing through the barrel 131.

The retention time of the solids in the RTD 129 can be varied between about 30 minutes to about 105 minutes via variable-speed drive system that rotates the barrel 131. Retention times can also be varied through the use of different flight configurations within the rotating barrel. There are both mixing and turning flights within the barrel that are continually both shifting and transporting the bed of material within the barrel. The flights also aid in the transfer of heat to the solids inside the barrel 131. Much like a cooking oven, the insulated oven chamber 130 of the RTD 129 is well insulated to save energy and to ensure the exposed housing does not pose a danger to equipment operators and servicers working about the exterior of the RTD 129. The rotatable barrel 131 is operated under a constant negative pressure (a partial vacuum) to ensure that volatilized contaminants are not released into the atmosphere as fugitive emissions.

### 4. Burner Train

Heat is supplied to the outside of the rotatable barrel 131 by a burner train (BT) 132, which includes bank of burners located within the insulated oven chamber 130. The burner train 132 is parallel to the axis of the rotatable barrel 131, and the firing rate of the burners can be adjusted individually or together as a group. This allows the operator to create either a constant or stratified heating profile in the rotatable barrel 131, depending on the application.

The individual burners of the burner train 132 are fed with heavy condensate from the condensate storage tank (CST) 120 by a burner fuel pump (BFP) 135 through a sixth conduit (6C) 134. A typical RTD 129 has from four to six burners installed within the insulated oven chamber 130, and each burner provides a heat output of between about 2.5 to about 5.0 million BTU per hour. The preferred embodiment RTD 129 of the present disclosure operates with five, 2.5 million BTU rated burners. The burner train 132, which includes all safety components, valves and piping necessary to operate the burners, is indirectly connected to the insulated oven chamber 130 because the burner heads are the last items in the burner train 132. Multiple thermocouple probes, which monitor temperatures within the insulated oven chamber 130, are spaced throughout the insulated oven chamber 130.

### 5. Soil Conditioner

When the solid materials have been remediated and exit the rotatable barrel (RB) 131, they are discharged from the bottom of the flue 137 to the exterior through a series of PLATCO® double dump valves (DDV) 155. PLATCO® double dump valves 155 are valves that are pneumatically operated and open and close in opposite patterns so that no more than minuscule amounts of air can enter the barrel. From the PLATCO® double dump valves 155 the material enters a soil conditioner (SC) 157 having an internal soil conditioner auger (SCA) 158, a water nozzle array (WNA) 159, in which water spray nozzles are positioned linearly about every 35 cm (about 14 inches). Water is fed to the water nozzle array 159 by a high-pressure pump (HPP) 160. Water from upstream nozzles knocks down any dust from the remediated material. Water from downstream nozzles cools the remediated material before it exits the machine as hydrocarbon-free sand and clay (HFSC) 161 particles. The soil conditioner 157 is built with a heavy steel casing that encompasses the auger 158 and also contains slots for thermocouples, which monitor temperature.

### 6. System Exhaust Pump

A high-capacity exhaust pump (SEP) 148, or exhaust fan, is preferably located just after the quench chamber, which begins at the exit of the rotatable barrel 131. The exhaust pump 148, which applies a partial vacuum to the exit of the RTD 129, sucks the off gases into the quench chamber (QC) 139 from the flue 137 at the exit of the RTD 139.

There are several segments of ducting that connect the exhaust pump 148 to the base of the quench chamber 139. The exhaust pump 148 has a damper, which is controlled by the operator in a control shack. The exhaust pump 148 applies a partial vacuum that extends all the way from the quench chamber 139, through the flue 137 of the RTD 129, through the rotatable barrel 131, to the material exit end of the air-tight infeed auger (AIA) 128. Any vapors that have managed to pass through the quench chamber (QC) 139 without being condensed are exhausted by the system exhaust pump 148, through a ninth conduit (9C) 149 to a heat exchanger (HE) 150, which condenses any remaining hydrocarbon vapors to liquid condensate, which can be transferred to the quench supply and recovery tank (QSRT) 140 through a tenth conduit (10C) by a fourth transfer pump (4TP) 152. Any remaining gases are passed through a vent duct (VD) 154, through a carbon vessel (CV) 153, where any remaining potential pollutants are adsorbed onto a carbon filter and, finally, out to the atmosphere.

### 7. Off-Gas Conditioning System

The venting of final off gases to the atmosphere was explained in a simplified manner previously. The illustrative treatment of off gases can be more complex. Contaminants volatilized from the tar sands in the rotatable barrel (RB) 131 are transferred to an off-gas conditioning system for particulate removal in a bag house (not shown). Any remaining volatile contaminants are condensed and collected. Finish polishing of exiting gases completes the process. The off-gas treatment system is a recovery-style air pollution control system, and destruction of the off-gases does not occur. The off-gas treatment system is operated under constant negative pressure to ensure that volatilized contaminants are not released as fugitive emissions. A system of seals and mechanical airlocks are utilized to minimize the amount of leakage into the atmosphere. The sweep gas oxygen level is monitored and maintained below the criteria set for each specific project to maintain a safe and stable process. Once the contaminants have been recovered from the off-gas, the process gas stream is vented to atmosphere below the required emission standard.

### Quench Chamber

The illustrative quench chamber (QC) 139 will now be described in detail. The quench chamber 139 is an enclosed, vertically-oriented structure where the off gases are sprayed with a quenching agent in order to cool and condense the off gases to a liquid. As the off gases arrive at the quench chamber 139 within a temperature range of about 399 to about 427° C. (about 750 to about 800° F.) they are still in a vapor state. The off gases should be cooled within the quench chamber 139 a temperature of around 121° C. (250° F.) in order to condense them to a liquid. The quench chamber 139 is equipped with multiple, strategically placed spray nozzles (QNZ) 141.

Each spray nozzle is controlled by a gate valve that can be used to adjust its rate of discharge of condensate. Fluid pressure at the nozzles 141 can also be controlled by the speed of the centrifugal quench circulation pump (QCP) 142 that supplies condensate to the nozzles under pressure. It is estimated that between about 6.625 to about 11.35 liters (about 1.75 to about 3 gallons) of condensate are discharged through each of the nozzles per minute.

The illustrative process provides the advantage of using off-gas condensate to cool incoming off gases. The condensate can come from two different sources. The condensate, which is stored in a mixing tank, can either be derived from the tar sands being recycled in the RTD 129 or, at system start-up, they can be provided by an off-site source (i.e., a refinery). If so desired, all condensate employed by the process can be produced on site. The use of off-site acquired condensate merely simplifies and accelerates the startup process.

### Upgrade of Condensate

As clean condensate used for quenching (cooling) and volatilized off gasses from the RTD 129 are combined in the quench chamber 139 an upgrading, or cracking, process begins to take place. Testing has shown that the actual API number of the virgin condensate begins to rise. The light ends of the bitumen that are volatilized and face cracking in the rotatable barrel (RB) 131 are carried into the quench chamber 139 at temperature within a range of about 399 to about 427° C. (about 750 to about 800° F.). When the sprayed virgin condensate from the nozzles (QNZ) 141comes in contact with the off gases from the RTD, mixing and cracking process are initiated. The mixing combined with temperature and pressures create a new product of greater API number. The API number of the condensate in the quench supply and recovery tank (QSRT) 140, which is used for both quenching of off gases and as an extraction fluid for dissolving the bitumen during the mechanical mixing and agitation steps, can be increased by recirculating it for as long a period as needed by bypassing the mixing and agitation steps, and only adding otherwise-unprocessed pulverized tar sands to the hopper of the air-tight infeed auger (AIA) 128. The more the condensate is recycled the higher the API number. As the API number of the condensate in the quench tank approaches the desired API number, the mix and agitation steps can be resumed.

### System Removal Points for Hydrocarbons

The system has two separate removal points for the hydrocarbons. The first hydrocarbon removal point is the condensation gathering apparatus, which includes the quench chamber (QC) 139, the quench supply and recovery tank (QSRT) 140 at the base of the quench chamber 139 and, at startup, the heat exchanger (HE) 150 and associated storage tank (not independently shown). Off gases enter the quench chamber 139 from the flue 1137 at the exit end of the RTD 129. The second hydrocarbon removal point is the dual-phase centrifuge (DPC) 114.

The centrifuge 114 is located on the material agitation trailer. There are two hydrocarbon extraction points on the dual-phase centrifuge 114. These extraction points are located at different positions on the centrifuge because of the differences in the specific gravity of the hydrocarbons being subjected to high rotational g-forces within the centrifuge.

American Petroleum Institute (API) gravity is a measure of how heavy or light a petroleum liquid is compared to water: if its API gravity is greater than 10, it is lighter and floats on water; if less than 10, it is heavier and sinks. Thus, API gravity is an inverse measure of a petroleum liquid's density relative to that of water (also known as specific gravity). It is used to compare densities of petroleum liquids. For example, if one petroleum liquid is less dense than another, it has a greater API gravity. Bitumen and heavy condensate are the two principal products released from the centrifuge; lighter carbon chain materials remain in the centrifuge cake, and are recovered at the quench chamber 139.

### Tar Sand Extraction Process Control System

The process control system is a critical element in the operation of the plant equipment. The key elements of the process control system include:
A Display Console that is monitored by a Control Room Operator;
A micro computer;
A burner control and flame safety management system;
Instruments for monitoring process data; and
A programmable logic controller (PLC)

The Control Room Operator's display console is a flat-screen computer monitor that shows schematic diagrams of each part of the plant and the values of current operating parameters. The Control Room Operator can adjust many of the operating parameters through the computer screens.

The burner control and flame safety system is a Honeywell Model RM 7890 that contains the control logic for managing burner safety functions. Examples of functions that are performed by the burner control system include purging the equipment with air for a pre-defined time period before the burners can be ignited, checking that air and fuel flows and pressures are appropriate, and shutting off the fuel supply if a flame is not detected.

Instruments for monitoring process data include temperature, pressure, flow, pH, level, and amperage sensors. Most of these sensors send a signal back to the control room, where it can be read by the Control Room Operator and recorded by the data logger. However, there are some sensors that are local monitors only and must be read directly from the instrument by one of the Pad Operators. These parameters cannot be seen' directly by the Control Room Operator and are not recorded on an electronic media.

A programmable logic controller, or PLC, is a small programmable computer that contains the control logic for operating the plant. One PLC is utilized to control the RTD processing operations. There are also other specialized PLCs, which control functions such as pulsing of the baghouse dust collector and operation of the Continuous Emission Monitoring (CEM) system.

The PLC programming is structured as “ladder logic.” An example of a function performed by ladder logic would be control for the burner bank of the RTD. The gasses leaving the RTD should be maintained at a predetermined temperature (set point). A thermocouple senses the temperature and sends a signal to the PLC, which then converts the signal into a temperature reading. If the temperature is too low, the ladder logic programmed into the PLC will send a signal to open the burner fuel valves to increase the amount of fuel going to the burners. If the temperature is too high, the ladder logic programmed into the PLC will send a signal to close the fuel valves to decrease the amount of fuel going to the burners.

In addition to containing ladder logic and target operating set points, the PLCs also generate alarms to warn the Control Room Operator if process parameters are approaching a limiting value. The alarms give the Control Room Operator time to make adjustments to the process before a parameter goes outside of an allowable range.

The control system also triggers interlocks. An interlock is a safety feature that turns off certain equipment or adjusts defined operating parameters to protect the plant in case a control parameter goes outside of an allowable range. For example, if the gas temperature at the exit of the RTD were to get too high, it could damage the RTD oven shell and the RTD discharge hood. A high temperature interlock would either turn off or reduce the fuel flow to the burner array in order to reduce the exit gas temperature.

### Initial Production of Condensate

At system startup, there is no condensate (hot or otherwise) to feed the material mix tank (MMT) 108. Consequently, in order to initialize the system, condensate must be produced by skipping the preprocessing of the tar sands in the material mix tank 108, the agitation tank (AT) 111 and the dual-phase centrifuge (DPC) 114. Thus, at system startup, tar sand materials that have been pulverized in the crusher and screened for proper particle size are dumped directly, by an excavator, onto the third elevated conveyor (3EC) 126 that feeds the infeed auger hopper (IAH) 127 of air-tight infeed auger (AIA) 128 that introduces material into the rotatable barrel (RB) 131 of the rotary thermal desorber (RTD) 129. The interior of the rotatable barrel 131 is maintained at negative pressure by the high-capacity system exhaust pump 148. At zero-time startup, there is no condensate at all, so quenching of the off gases is not employed. Rather, the heat exchanger 150 located after the high-capacity system exhaust pump 148 is relied on to condense the of gases. The heat exchanger 150 includes a condensation chamber where the condensate can be stored. When a sufficient quantity has been accumulated, it can be transferred to the quench supply and recovery tank (QSRT) 140 at the base of the quench chamber (QC) 139, where it can be used to begin the quenching operation. Once a sufficient quantity of condensate has been accumulated in the QSRT 140, some can be sent to the material mix tank (MMT) 108, and from there, to the agitation tank (AT) 111.

Once the centrifuge 114 has processed the slurry and started sending centrifuge cake to the infeed auger hopper (IAH) 127 of the air-tight infeed auger (AIA) 128 of the RTD 129, loading of pulverized tar sands directly onto the third elevated conveyor (3EC) 126, that feeds the infeed auger hopper 127, can stop. The percentage of hydrocarbons in the tar sands determines how long the third elevated conveyor 126 will be excavator fed. The more hydrocarbons in the tar sands, the faster the quench supply and recovery tank (QSRT) 140 is filled. It is important to remember that direct feeding of the air-tight infeed auger 128 is generally used only at startup to create hot extraction fluids. However, direct feeding of the air-tight infeed auger 128 can also be used as a means to upgrade the condensate by increasing its API number. During such upgrading, the mixing and agitation steps are suspended.

Tar sand material loaded on the third elevated conveyor 126 enters the hopper 127 and drops into the air-tight infeed auger 128. Although feed hoppers vary in the amount of material they can hold, a three-cubic-yard capacity is common. The infeed auger hopper 127 is welded on the casing which contains the feed auger. Feed augers range in size from ten inches to eighteen inches. An electric motor powers the air-tight infeed auger 128; the motor is fitted with a variable speed control. It hardly need be stated that the air-tight infeed auger 128 must be kept filled at all times to prevent air (oxygen) from entering the RTD 129 through the auger 128. If oxygen were to enter the rotatable barrel 131 during operation of the RTD 129, a massive RTD-destroying explosion would likely occur. In order to further reduce the potential for explosions, animal fat can be added to the condensate as a flame retardant.

Although only a single illustrative embodiment of the method and apparatus for extracting bitumen from oil-wetted tar sands 100 has been shown and described, it will be clear to those having ordinary skill in the art that changes and modifications may be made thereto without departing from the scope and the spirit of the invention as hereinafter claimed.

For example, in another embodiment of the invention, hydrocarbons can be removed from material by passing materials that have been pulverized in the crusher and screened for proper particle size directly into the infeed auger hopper (IAH) 127 of the air-tight infeed auger (AIA) 128 that introduces material into the rotatable barrel (RB) 131 of the rotary thermal desorber (RTD) 129. The off gases are drawn into the quench chamber by the system exhaust pump. As the off gases arrive at the quench chamber 139 within a temperature range of about 399 to about 427° C. (about 750 to about 800° F.) they are still in a vapor state. The quench chamber 139 is equipped with multiple, strategically placed spray nozzles (QNZ) 141, as in prior embodiments, and the off gases are cooled to a temperature of around 121° C. (250° F.) in order to condense them to a liquid, which passes into the quench supply and recovery tank 140.

What is claimed is:

1. An apparatus for extracting bitumen from oil sands material and obtaining useful products from it, the apparatus comprising:
a crusher,
a primary material mix tank,
a dual-phase centrifuge,
a condensate storage tank,
an air-tight indirect-fired rotary thermal desorber,
a quench chamber,
a quench supply and recovery tank.

2. The apparatus of claim 1 wherein the crusher can be adjusted to produce particles with a maximum size of between about ¼ inch and about ¾ inches.

3. The apparatus of claim 1 also comprising an infeed auger hopper attached to an airtight infeed auger, which feeds material into the rotary thermal desorber.

4. The apparatus of claim 1 wherein the indirect fired rotary thermal desorber comprises an axially rotatable barrel housed within an externally-insulated oven chamber, wherein the axially rotatable barrel is equipped with variable flights which are positioned to both transport the tar sands material from one end of the barrel to the other end as it rotates, and to mix material within the barrel.

5. The apparatus of claim 4 wherein the axially rotatable barrel rotates between 0.5 and 3 revolutions per minute and the retention time for solids within the barrel can be varied between 30 and 105 minutes.

6. The apparatus of claim 4 also comprising a burner train within the externally insulated oven chamber, wherein the burner train is parallel to the axis of the axially rotatable barrel.

7. The apparatus of claim 6 wherein the firing rate of the burners can be adjusted individually or as a group.

8. The apparatus of claim 6 wherein the burners are fed with heavy condensate from the condensate storage tank.

9. The apparatus of claim 6 comprising four to six burners in the burner train, each providing between approximately 2.5 and 5.0 million BTU per hour.

10. The apparatus of claim 4 wherein the oven also contains multiple thermocouple probes to monitor temperature within the insulated oven chamber.

11. The apparatus of claim 4 also comprising an exhaust stack with an adjustable exit aperture connected to the externally-insulated oven chamber which can allow excess heat to be released to the atmosphere.

12. The apparatus of claim 1 wherein the indirect fired rotary thermal desorber can be heated to maintain an internal temperature over 400 degrees C.

13. The apparatus of claim 1 also comprising a soil conditioner.

14. The apparatus of claim 13 wherein soil transfers from the rotary thermal desorber to the soil conditioner via a series of double dump valves.

15. The apparatus of claim 13 wherein the soil conditioner comprises an internal soil conditioner auger and a water nozzle array, wherein water is fed to the water nozzle array by a high-pressure pump.

16. The apparatus of claim 13 wherein the soil conditioner contains slots for thermocouples to monitor temperature.

17. The apparatus of claim 1 wherein the quench chamber is connected to the rotary thermal desorber via ductwork.

18. The apparatus of claim 17 also comprising a high-capacity exhaust pump connected to the quench chamber.

19. The apparatus of claim 18 also comprising a heat exchanger connected to the quench chamber via ductwork.

20. The apparatus of claim 19 wherein the heat exchanger is connected to the quench supply and recovery tank via a conduit and a transfer pump.

21. The apparatus of claim 18 also comprising a vent duct and a carbon vessel containing a carbon filter.

22. The apparatus of claim 1 wherein the quench chamber is an enclosed, vertically-oriented structure situated above the quench supply and recovery tank in such a way that condensate which is cooled in the quench chamber can drain into the quench supply and recovery tank.

23. The apparatus of claim 1 wherein the quench chamber is equipped with multiple spray nozzles controlled by a gate valve, each connected to a quench circulation pump.

24. The apparatus of claim 23 wherein the quench circulation pump is designed to draw condensate from the quench supply and recovery tank.

25. The apparatus of claim 1 also comprising a process control system, wherein the process control system comprises:
a display console which can be monitored by a Control Room Operator;
a micro computer;
a burner control and flame safety management system;
instruments for monitoring process data; and
a programmable logic controller (PLC).

26. The apparatus of claim 25 wherein many of the operating parameters of the apparatus can be monitored by the display console and adjusted through the micro computer.

27. The apparatus of claim 25 also comprising additional, specialized programmable logic controllers which control specific steps in the process.

28. The apparatus of claim 25 wherein the programmable logic controller generates an alarm if process parameters are approaching a limiting value.

29. The apparatus of claim 25 wherein the control system triggers an interlock if a control parameter goes outside of an allowable range.

30. A process for extracting bitumen from oil-wetted tar sands and converting it into useful petroleum products, comprising:
providing raw, mined tar sand material;
crushing the raw mined tar sand material;
heating the materials in an indirect-fired rotary thermal desorber;
passing the vapors from the rotary thermal desorber through a quench tank;
allowing the vapors to condense from the quench tank into a quench and supply recovery tank;

31. The process of claim 30 wherein tar sands material is crushed into pieces with a maximum particle size of about ¼ to about ¾ inches.

32. The process of claim 30 wherein the tar sand material is fed into the rotary thermal desorber via an infeed auger hopper on an air-tight infeed auger.

33. The process of claim 32 wherein the air-tight infeed auger is kept full of material at all times so that oxygen cannot enter the rotary thermal desorber.

34. The process of claim 30 wherein the internal temperature inside the rotary thermal desorber is maintained at above about 400 degrees C.

35. The process of claim 30 wherein the material in the rotary thermal desorber is retained within it for between about 30 and about 105 minutes.

36. The process of claim 30 wherein the rotary thermal desorber is operated at a constant negative pressure.

37. The process of claim 30 wherein the rotary thermal desorber produces an off gas stream of vapors and a stream of hydrocarbon-free solid particles.

38. The process of claim 37 wherein the stream of hydrocarbon-free solid particles from the rotary thermal desorber passes through a soil conditioner which sprays it with water from a series of nozzles.

39. The process of claim 38 wherein the solid particles pass out of the rotary thermal desorber via a series of double dump valves.

40. The process of claim 30 wherein the vapors in the quench chamber are cooled by spraying them with condensate which is below about 121 degrees C. in temperature.

41. The process of claim 40 wherein the condensate sprayed in the quench chamber to cool the vapors is obtained from the quench supply and recovery tank.

42. The process of claim 30 wherein the vapors enter the quench chamber at between about 345 and about 400 degrees C. and are cooled to below about 121 degrees C., allowing the vapors to condense and drain into the quench supply and recovery tank.

43. The process of claim 30 wherein the condensate and gases used in the quench chamber are recycled in the quench supply and recovery tank and quench chamber repeatedly and undergo an upgrading, or cracking process while in the quench chamber.

44. The process of claim 30 wherein condensate from the quench supply and recovery tank is pumped into the material mix tank.

45. The process of claim 30 wherein any vapors that are not cooled in the quench chamber pass through a heat exchanger and through a carbon vessel before passing into the atmosphere.

46. The process of claim 45 wherein the vapors not cooled in the quench chamber or heat exchanger also pass through an off-gas conditioning system for particulate removal in a bag house.

47. The process of claim 46 wherein the off-gas treatment system is a recovery-style air pollution control system.

48. The process of claim 46 wherein the off-gas treatment system is operated under constant negative pressure.

49. The process of claim 30 further comprising a computerized control system which monitors and displays the critical variables of the process and allows a controller to make changes to it.

50. The process of claim 30 wherein the quench supply and recovery tank is supplied with additional condensate from a condensate storage tank if necessary.
